(19) United States
(12) Patent Application Publication
(10) Pub. No.: US 2022/0324019 A1
(43) Pub. Date: Oct. 13, 2022

(54) ARTICLE INCLUDING SILICON CARBIDE AND METHOD OF MANUFACTURING SAME

(71) Applicant: CANON KABUSHIKI KAISHA, Tokyo (JP)

(72) Inventors: Koji Kitani, Chofu-shi (JP); Motoki Okinaka, Inagi-shi (JP); Tsutomu Miki, Komae-shi (JP)

(21) Appl. No.: 17/833,039

(22) Filed: Jun. 6, 2022

Related U.S. Application Data
(62) Division of application No. 16/720,328, filed on Dec. 19, 2019.

(30) Foreign Application Priority Data
Dec. 25, 2018 (JP) 2018-241871
Nov. 28, 2019 (JP) 2019-215791

(51) Int. Cl. B22F 3/105; B22F 3/26

(52) U.S. Cl. CPC B22F 3/105; B22F 3/26; B22F 2302/105; B22F 2302/05

(57) ABSTRACT

Provided is an article that includes silicon carbide as a main component and that has sufficient mechanical strength while manufactured by a three-dimensional shaping technology. The article that includes silicon carbide as a main component includes: silicon carbide; a metal boride having a melting point lower than a sublimation point of silicon carbide; and metal silicon.

### CROSS-REFERENCE TO RELATED APPLICATIONS

This application is a divisional application of U.S. patent application Ser. No. 16/720,328, filed Dec. 19, 2019, which claims the benefit of Japanese Patent Applications No. 2018-241871, filed Dec. 25, 2018, and No. 2019-215791, filed Nov. 28, 2019. All of these prior applications are hereby incorporated by reference herein in their entirety.

### BACKGROUND OF THE INVENTION

### Field of the Invention

The present disclosure relates to an article using a material based on silicon carbide, which has material features such as high heat resistance, high thermal conductivity, light weight, and high stiffness, and more particularly, to an article manufactured by powder bed fusion, which is an additive manufacturing method, and to a method of manufacturing the same.

### Description of the Related Art

In order to manufacture a wide variety of metal components in small quantities or to manufacture a metal component having a complicated shape, a three-dimensional shaping technology using powder bed fusion has been developed. The technology involves repeating, for a plurality of layers, a step of scanning a powder layer of a build material with an energy beam based on slice data generated from the three-dimensional shape data of an object to be shaped to locally melt/solidify the build material, to thereby form a three-dimensional object. A laser beam, an electron beam, or the like is used as the energy beam.

In addition, in recent years, investigations have been made on the shaping of a ceramic material, such as silicon carbide, which is difficult to process, by such three-dimensional shaping technology. However, most of ceramics, such as a carbide, a boride, and a nitride, have technical problems in that the ceramic is sublimated without being melted when energy is abruptly given thereto, and the ceramic becomes fragile without being crystallized when the ceramic is melted and solidified. Silicon carbide, which is excellent in light weight property, abrasion resistance, thermal shock resistance, chemical stability, and the like, and which is expected to find applications in a wide variety of fields, is a material that does not have a melting point at normal pressure and is sublimated at around 2,545° C. (another value for the temperature, such as 2,700° C., is also known).

In Japanese Patent Application Laid-Open No. 2016-527161, there is disclosed candidate powder capable of being shaped through utilization of transient liquid phase bonding using of, for example, a eutectic crystal or a peritectic crystal. As examples of candidate powder for manufacturing a shaped object formed of silicon carbide, a mixture of silicon carbide, aluminum oxide, a rare earth oxide, and silica, a mixture of silicon carbide, aluminum nitride, and a rare earth oxide, and a mixture of silicon carbide and metal germanium are presented.

The powder described in Japanese Patent Application Laid-Open No. 2016-527161 includes, as an essential material, silica, aluminum nitride, or metal germanium as a material to be mixed with silicon carbide in order to form a eutectic crystal. However, silica is decomposed into silicon monoxide and oxygen at 1,900° C. In addition, aluminum nitride is sublimated at 2,200° C. Also metal germanium boils at 2,400° C. or less. Owing to the foregoing, when those materials are heated simultaneously with silicon carbide having a sublimation point of 2,545° C., those materials have high possibility of being volatilized before silicon carbide is melted. In addition, although there is no disclosure of the strength of the shaped object, it is suspected that a shaped object in which the powders are partially bonded to each other, and which has low strength may be formed.

In view of the above-mentioned problems, an object of the present disclosure is to provide a shaped object that includes silicon carbide as a main component, and that has sufficient mechanical strength while manufactured by a three-dimensional shaping technology. Another object of the present disclosure is to provide a method of manufacturing such shaped object.

### SUMMARY OF THE INVENTION

According to one aspect of the present disclosure, there is provided an article including: silicon carbide; a metal boride having a melting point lower than a sublimation point of silicon carbide; and metal silicon.

In addition, according to one aspect of the present disclosure, there is provided a method of manufacturing an article including: forming a shaped object by repeating: forming a powder layer through use of mixed powder of powder containing silicon carbide and powder containing a metal boride having a melting point lower than a sublimation point of silicon carbide; and scanning and irradiating the formed powder layer with an energy beam based on shape data of an object to be shaped to melt and solidify the powder; and further impregnating the formed shaped object with metal silicon.

Further features of the present invention will become apparent from the following description of exemplary embodiments with reference to the attached drawings.

### BRIEF DESCRIPTION OF THE DRAWINGS

FIG. 1 is a schematic view of a three-dimensional shaping apparatus to be used in a manufacturing method according to one aspect of the present disclosure.

FIG. 2 is a view for illustrating a state in which a shaped object is impregnated with metal silicon.

FIG. 3 is a schematic view of a shaped object manufactured in Example according to one aspect of the present disclosure.

FIG. 4 is a SEM image of a cross section of Sample 1 manufactured according to one aspect of the present disclosure.

FIG. 5 is a view for showing a three-dimensional structure obtained by piecing together only dense-colored regions in the sectional SEM image of FIG. 4.

FIG. 6 is a view for showing a three-dimensional structure obtained by piecing together only light-colored regions in the sectional SEM image of FIG. 4.

FIG. 7 is an optical micrograph of a cross section of Sample 1 manufactured according to one aspect of the present disclosure.

FIG. 8 is a SEM image of a cross section of Sample 6 manufactured according to one aspect of the present disclosure.

FIG. 9 is an optical micrograph of a cross section of Sample 6 manufactured according to one aspect of the present disclosure.

### DESCRIPTION OF THE EMBODIMENTS

Now, embodiments of the present disclosure are described with reference to the attached drawings.

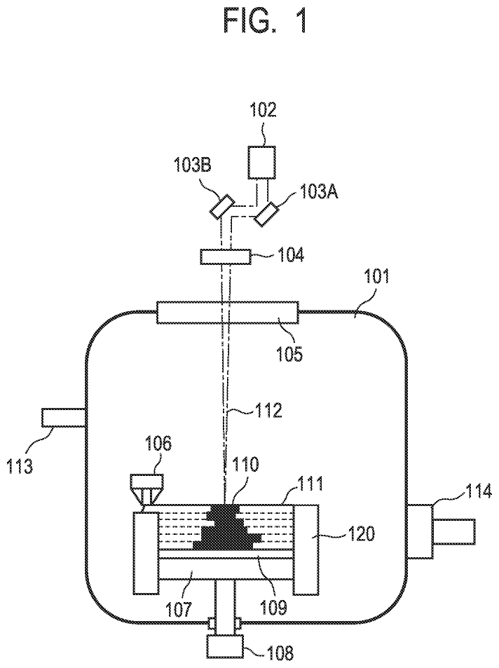

First, a shaping apparatus that can be applied to a manufacturing method according to one aspect of the present disclosure is described with reference to FIG. 1. The shaping apparatus includes a chamber 101 in which its internal atmosphere can be controlled by a gas introduction mechanism 113 and an exhaust mechanism 114. The chamber 101 includes: a shaping container 120 configured to form a three-dimensional object; and a powder layer-forming mechanism 106 configured to form a powder layer 111 by spreading powder serving as a build material (hereinafter sometimes simply referred to as “build material” or “powder”) in the shaping container 120.

In order to adjust a pressure, the exhaust mechanism 114 may include a pressure-adjusting mechanism, such as a butterfly valve, or may have a configuration (generally called “blow purge”) in which an atmosphere in the chamber can be adjusted in association with gas supply and an increase in pressure along with the gas supply.

The shaping container 120 includes, at the bottom thereof, a stage 107 in which its position can be changed in a vertical direction by a lifting mechanism 108. A moving direction and a moving amount by the lifting mechanism 108 are controlled by a control unit (not shown), and the moving amount of the stage 107 is determined in accordance with the thickness of the powder layer 111 to be formed. The stage 107 includes, on a shaping surface side thereof, a structure (not shown) on which a base plate 109 is arranged. The base plate 109 is a plate formed of a meltable material, such as stainless steel. The surface of the base plate 109 is melted together with the build material when a first powder layer is melted and solidified, to thereby allow a shaped object to be fixed to the base plate. With this, during shaping, the shaped object can be held on the base plate 109 without a positional shift. After the completion of the shaping, the base plate 109 is mechanically separated from the shaped object.

The powder layer-forming mechanism 106 includes: a powder storage unit configured to store a powder material; and a supply mechanism configured to supply the powder material to the shaping container 120. Further, any one or both of a squeegee and a roller each configured to flatten the powder layer to a preset thickness may be arranged on the base plate 109.

The shaping apparatus further includes: an energy beam source 102 configured to melt the build material; scanning mirrors 103A and 103B configured to two-axis scan energy beams 112; and an optical system 104 configured to focus the energy beams on an irradiation portion. The energy beam 112 is radiated from an outside of the chamber 101, and hence the chamber 101 includes an introduction window 105 configured to introduce the energy beam 112 to an inside. The power density and scanning position of the energy beam are controlled by the control unit based on the three-dimensional shape data of an object to be shaped and the characteristics of the build material acquired by the control unit (not shown). In addition, the positions of the shaping container 120 and the optical system 104 are adjusted in advance so that the energy beams are focused in the vicinity of the surface of the powder layer 111 with an appropriate beam diameter. The beam diameter on the surface, which affects shaping accuracy, is preferably set to from 30 μm to 100 μm.

Next, a manufacturing method according to one aspect of the present disclosure is described. First, the base plate 109 is placed on the stage 107, and an inside of the chamber 101 is purged with an inert gas, such as nitrogen or argon, introduced by the gas introduction mechanism 113. After the completion of the purging, the powder layer 111 is formed on the base plate 109 by the powder layer-forming mechanism 106. The powder layer 111 is formed at a thickness corresponding to a slice pitch of slice data generated from the three-dimensional shape data of the object to be shaped, that is, a lamination pitch.

The powder to be used for the shaping in one aspect of the present disclosure is mixed powder of: powder of silicon carbide serving as a main component; and powder of a metal boride having a melting point lower than the sublimation point of silicon carbide. Powder of a compound other than the foregoing may be included as long as the characteristics of silicon carbide are not largely impaired. The particle sizes of the powder of silicon carbide and the powder of a metal boride are each preferably from 3 μm to 100 μm, more preferably from 5 μm to 50 μm because, when the particle sizes are excessively small, the powders aggregate with each other, and a powder layer having a uniform thickness cannot be formed, and when the particle sizes are excessively large, high energy is required for the melting of the powders, and the shaping becomes difficult. In addition, the thickness of the powder layer per layer, which affects the shaping accuracy, is suitably from about 30 μm to about 100 μm.

Now, measurement methods for the particle diameters of the powders in one aspect of the present disclosure are described. The particle diameters included in each powder have a distribution within a certain range, and its median value and maximum particle diameter are specified. The particle diameter of SiC is measured by an electrical resistance test method in accordance with “Bonded abrasives-Determination and designation of grain size distribution” of JIS R 6001-2, which conforms to a standardized evaluation method for the particle diameter in the field. The particle diameters of chromium monoboride, chromium diboride, and the like, other than SiC, are measured in accordance with “Determination of particle size distributions-Electrical sensing zone method” of JIS Z 8832.

Next, the energy beam 112 is scanned based on the slice data and radiated to the powder in a predetermined region of the powder layer 111 to melt the powder. It is preferred to use, as the energy beam source 102, a source capable of outputting energy having a wavelength at which the build material has a high absorption rate of 50% or more. In particular, during the shaping, in order that a state in which the molten metal boride surrounds silicon carbide is created, it is preferred to use an energy beam within a wavelength region in which the metal boride has a high absorption rate. When the build material includes chromium diboride, a semiconductor fiber laser at a wavelength of from 1,000 nm to 1,120 nm is suitable.

The energy beam 112 preferably has energy strength in such level that the powder in the irradiation region with the energy beam is melted and solidified in several milliseconds and particles thereof are bonded to each other. When the powder layers are laminated, it is required for the shaping that a powder layer positioned on an outermost surface on an irradiation side with the energy beam 112 be melted and solidified, and as well, that a powder layer immediately below the powder layer irradiated with the energy beam 112 be melted and solidified to some extent. When the melting of the powder layer immediately below the powder layer irradiated with the energy beam 112 is insufficient, the powder layers are liable to be peeled off from each other, resulting in a shaped object having low strength. At the time of melting and solidification of the first powder layer spread immediately above the base plate 109, the irradiation conditions of the energy beam are adjusted in consideration of the heat capacity, thermal conductivity, and the like of the base plate so that the surface of the base plate 109 is melted simultaneously.

Subsequently, after the stage 107 for shaping is caused to descend by the lifting mechanism 108 by the lamination pitch, the powder is spread on a layer having been scanned by the energy beam to form a new powder layer, and the new powder layer is scanned and irradiated with the energy beam 112. As described above, when the new powder layer is irradiated with the energy beam 112, part of the layer having been scanned by the energy beam 112 (specifically, a portion brought into contact with the new powder layer) is melted and solidified again in first. When a region having already been melted and solidified lies immediately below an irradiation region of the new powder layer with the energy beam 112, the irradiation region of the new powder layer with the beam is mixed with a molten material in part of the region having been melted and solidified, solidified therewith, and bonded thereto. When those operations are repeated, a shaped object 110 in which the regions having been melted and solidified with the energy beam 112 layer by layer are integrated with each other can be formed.

The shaped object 110 is bonded to the base plate 109, and hence is taken out from the chamber 101 together with the base plate. After that, the base plate 109 and the shaped object 110 are cut with, for example, a wire saw or a disc blade to which abrasive grains formed of diamond or the like are attached to be separated from each other. Thus, the shaped object 110 can be obtained.

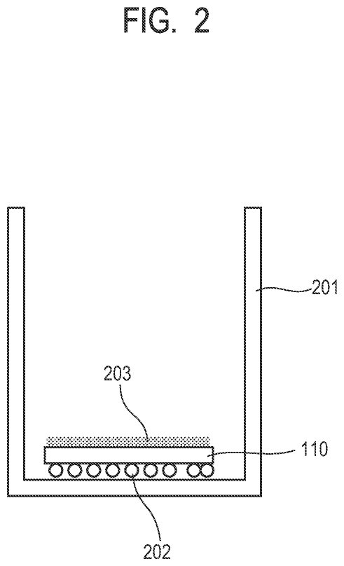

Next, an example of a step of impregnating the shaped object with metal silicon is described with reference to FIG. 2. A heat-resistant spherical objects 202 having uniform particle diameters are spread so that a thickness does not become a thickness equal to or more than two layers at the bottom of a crucible 201 formed of a material, such as graphite, that does not undergo volatilization, alternation, or the like even at the melting point (1,414° C.) of metal silicon, and the shaped object 110 is placed thereon. The heat-resistant spherical objects 202 have an effect of causing a gap so that the crucible 201 and the shaped object 110 are prevented from being strongly fixed to each other by a solidified object of metal silicon having seeped out from the shaped object 110 during the impregnation step.

Further, the porosity of the shaped object 110 is derived based on the shape and mass of the shaped object 110 in advance, and a metal silicon powder 203 is placed on the shaped object in an amount larger than the amount corresponding to pores. After that, the shaped object 110 and the metal silicon powder 203 are loaded in a vacuum heat treatment furnace together with the crucible 201, and an inside of the furnace is purged with argon, appropriately reduced in pressure, and heated from room temperature to a temperature exceeding 1,414° C., which is the melting point of the metal silicon, for example, 1,500° C. The metal silicon liquefied through the heating to a temperature exceeding the melting point penetrates into the pores of the shaped object. After that, cooling is performed, and at the time when the temperature reaches room temperature, dry air is introduced to return the pressure to the atmospheric pressure, and the crucible is taken out from the vacuum heat treatment furnace. At the time of cooling, a temperature change rate is reduced at a temperature around the melting point of metal silicon so that strain or stress to be generated owing to different solidification timings depending on positions is prevented. The heat-resistant spherical objects 202 adhering to the surface of the shaped object by the solidified object of metal silicon having seeped out from the shaped object 110 are removed, and further, the shape and surface of the shaped object are arranged by grinding, polishing, and the like. Thus, a desired article can be obtained.

[Powder Material to be Used in One Aspect of the Present Disclosure]

In one aspect of the present disclosure, powder of silicon carbide and powder of a metal boride that forms a eutectic crystal or a hypoeutectic crystal with silicon carbide and has a melting point lower than the sublimation point of silicon carbide are mixed with each other to provide build powder. When a shaped object including a eutectic crystal or a hypoeutectic crystal of silicon carbide and the metal boride is manufactured through use of such build powder, a shaped object having strength close to that in the case of silicon carbide alone is achieved.

Now, the eutectic crystal/hypoeutectic crystal is described below.

A mixture of a material X and a material Y, such as a metal, has a material ratio at which the melting point of the mixture is lower than the melting point of each of the materials. In this case, a material ratio offering the lowest melting point is referred to as “eutectic composition”, and the lowest melting point is referred to as “eutectic temperature”.

In the eutectic composition, both the material X and the material Y form liquid phases at a temperature equal to or higher than the melting point, and the material X and the material Y simultaneously deposit at a temperature lower than the melting point. Therefore, the material X and the material Y are formed of fine deposition phases, and a eutectic crystal having a structure in a layered shape called a lamella shape or the like and having high strength is obtained.

Next, a case of a mixture of the material X and the material Y including the material X in an amount larger than in the eutectic composition is considered. In this case, while the material X and the material Y form liquid phases at a temperature equal to or higher than the melting point, when a temperature falls below the melting point, the material X is first solidified, and the material X deposits (called an initial crystal) until the temperature reaches the eutectic temperature. Then, when the temperature is reduced to the eutectic temperature, the liquid phases except for a crystal of the material X having deposited have the eutectic composition. When the temperature is reduced from that state to a temperature lower than the eutectic temperature, the material X and the material Y simultaneously deposit. That is, there is achieved a structure having mixed therein the crystal of the material X having grown large because the deposition of the material X starts early as compared to the case in which the deposition of the material X starts from the eutectic composition. When the material Y is included in an amount larger than in the eutectic composition, a crystal of the material Y grows large. Those states are each called a hypoeutectic crystal. The eutectic crystal or the hypoeutectic crystal may be confirmed by observing a cross section of the shaped object with a scanning electron microscope.

In order to obtain physical properties close to those of silicon carbide, the inventors have made investigations on the conditions, such as a powder composition and a particle diameter, on which a state of the eutectic crystal or a state of the hypoeutectic crystal including a large crystal of silicon carbide is achieved.

### Examples

The present disclosure is described in more detail below by way of Examples and Comparative Examples. The present disclosure is by no means limited to the following Examples without departing from the gist of the present disclosure.

(Powder 1)

Silicon carbide powder (manufactured by Pacific Rundum Co., Ltd., product name: NC #800) having a median value of particle diameters of 14.7 μm was prepared as silicon carbide. Chromium diboride powder (manufactured by Japan New Metals Co., Ltd., product name: CrB2-O, median value of particle diameters: about 5 μm) having a melting point of 2,200° C. was prepared as chromium boride to be mixed. Those powders were blended at a molar ratio of silicon carbide:chromium diboride=7:3 so as to give powder having a composition in which a eutectic crystal or a hypoeutectic crystal was generated, and were mixed with a ball mill to obtain Powder 1. The way in which the molar ratio is determined and the way in which the powders are mixed are the same for other powders. The median value of particle diameters as used herein has the same meaning as a “median diameter”, and means a particle diameter at which a cumulative frequency reaches 50% in the powder. A particle diameter distribution may be measured by a well-known laser diffraction method or scattering method.

(Powder 2)

The same silicon carbide powder as in Powder 1 and vanadium diboride powder (median value of particle diameters: about 4 μm, manufactured by Japan New Metals Co., Ltd., product name: VB2-O) having a melting point of 2,400° C. were blended at a molar ratio of silicon carbide:vanadium diboride=1:1, and were mixed to obtain Powder 2.

(Powder 3)

The same silicon carbide powder as in Powder 1 and chromium monoboride powder (manufactured by Japan New Metals Co., Ltd., product name: CrB—O, median value of particle diameters: about 9 μm) having a melting point of 2,100° C. were blended at a molar ratio of silicon carbide:chromium monoboride=3:1, and were mixed to obtain Powder 3.

(Powder 4)

The same silicon carbide powder as in Powder 1 and titanium diboride powder (manufactured by Japan New Metals Co., Ltd., product name: TiB2-N, median value of particle diameters: about 4 μm) having a melting point of 2,920° C. were blended at a molar ratio of silicon carbide:titanium diboride=1:1, and were mixed to obtain Powder 4.

(Powder 5)

The same silicon carbide powder as in Powder 1 and zirconium diboride (manufactured by Japan New Metals Co., Ltd., product name: ZrB2-O, median value of particle diameters: about 5 μm) having a melting point of 3,200° C. were blended at a molar ratio of silicon carbide:zirconium diboride=1:1, and were mixed to obtain Powder 5.

The compositions of the powders are collectively shown in Table 1.

TABLE 1

| | Composition 1 | | | Composition 2 | | | |
|---|---|---|---|---|---|---|---|
| | | | Median value | | | Median value | Molar ratio |
| | Material | Sublimation | of particle | Material | Melting | of particle | Composition |
| | name | point [° C.] | diameters [μm] | name | point [° C.] | diameters [μm] | 1:Composition 2 |
| Powder 1 | Silicon | 2,545 | 14.7 | Chromium | 2,200 | 5 | 7:3 |
| | carbide | | | diboride | | | |
| Powder 2 | Silicon | 2,545 | 14.7 | Vanadium | 2,400 | 4 | 1:1 |
| | carbide | | | diboride | | | |
| Powder 3 | Silicon | 2,545 | 14.7 | Chromium | 2,100 | 9 | 3:1 |
| | carbide | | | monoboride | | | |
| Powder 4 | Silicon | 2,545 | 14.7 | Titanium | 2,920 | 4 | 1:1 |
| | carbide | | | diboride | | | |
| Powder 5 | Silicon | 2,545 | 14.7 | Zirconium | 3,200 | 5 | 1:1 |
| | carbide | | | diboride | | | |

[Manufacturing of Shaped Object Using Powder Material]

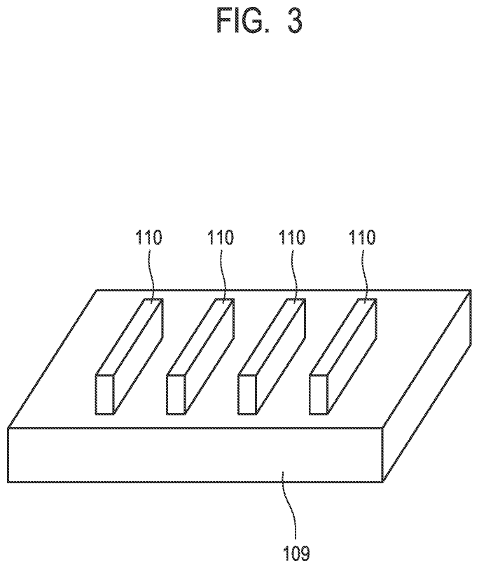

Shaping was performed through use of each of the above-mentioned Powders 1 to 5 serving as a material and the shaping apparatus illustrated in FIG. 1. Specifically, for each of the powders, four rectangular shaped objects each having a base area of 4 mm by 40 mm were manufactured on the base plate 109 made of stainless steel. A perspective view of the four shaped objects 110 and the base plate 109 after the completion of the shaping is illustrated in FIG. 3.

A semiconductor fiber laser at a wavelength of 1,070 nm was used as the energy beam source 102, and was radiated to a powder layer at a laser power of 100 W and an irradiation pitch of 50 μm. In addition, irradiation energy suitable for shaping varies depending on the kind of the powder material, and hence a scanning speed was conditioned in advance within a range of from 100 mm/sec to 1,000 mm/sec, and an optimum scanning speed for each material was set. The thickness of the powder layer (lamination pitch) was set to 30 μm, and the shaping of 300 layers was attempted.

However, in each of the shaping using Powder 4 including titanium diboride and the shaping using Powder 5 including zirconia diboride, a portion having been shaped started to be peeled off in the course of forming the powder layer, and the shaping was not able to be continued, and hence the shaping was stopped at that time. In each of the shaping using Powder 1, the shaping using Powder 2, and the shaping using Powder 3, a rectangle having a height of about 9 mm was obtained.

Next, a wire saw CS-203 (product name) manufactured by Musashino Denshi, Inc. was used as a cutting device. The shaped object 110 and the base plate 109 were separated from each other with the wire saw of 0.4 mmϕ to which diamond abrasive grains were attached.

Now, four samples of the shaped object using Powder 1 as material powder was obtained as Sample 1 (Comparative Example 1), four samples of the shaped object using Powder 2 as material powder was obtained as Sample 2 (Comparative Example 2), and four samples of the shaped object using Powder 3 as material powder was obtained as Sample 3 (Comparative Example 3). The shaping using Powder 4 as material powder and the shaping using Powder 5 as material powder were finished without being completed as described above, but were assigned Sample 4 serving as Comparative Example 4 and Sample 5 serving as Comparative Example 5, respectively, in terms of numbering.

Elements included in each of Samples 1 to 5 were identified by energy dispersive X-ray analysis (EDX), and the molecular structure of each of Samples 1 to 5 was identified by X-ray diffraction (XRD). It was found that, while Sample 1 included a slight amount of an oxide, which was presumed to be attributed to surface oxidation, Sample 1 was formed of silicon carbide and chromium diboride serving as raw material powders when the oxide was ignored. Similarly, it was found that Sample 2 was formed of silicon carbide and vanadium diboride.

In addition, how silicon carbide and the metal boride were distributed in a member was examined by FIB-SEM. FIB-SEM is a system in which, while a sample is excavated with a focused ion beam (FIB), an exposed sample surface or cross section is repeatedly observed with a scanning electron microscope (SEM), and the resultant SEM images are processed with a computer, to thereby three-dimensionally observe the structure of the sample.

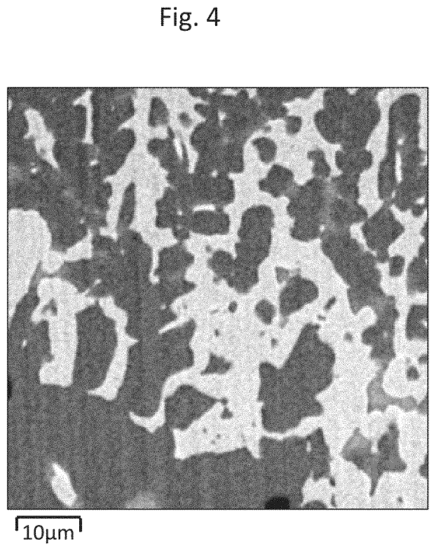

A SEM image of a cross section of Sample 1 is shown in FIG. 4. A portion 10 having the densest color represented pores, a region 12 having the lightest color was formed of chromium diboride, and a region 11 having a density between that of the region 10 and that of the region 12 was formed of silicon carbide. A boundary between the region 11 formed of silicon carbide and the region 12 formed of chromium diboride had a complicated shape, and hence it was able to be presumed that at least one of the materials was melted. In addition, based on the distribution of the region 11 formed of silicon carbide and the region 12 formed of chromium diboride observed in the SEM image, it was able to be confirmed that a eutectic crystal or a hypoeutectic crystal was formed.

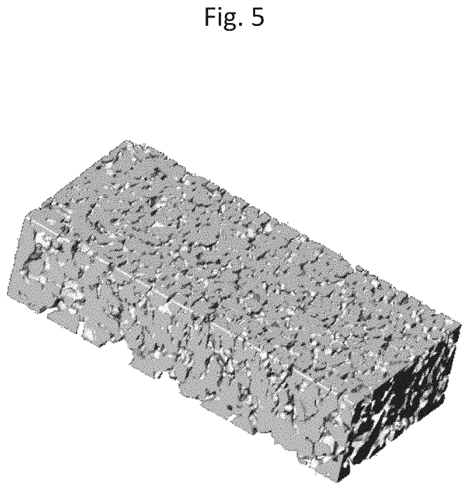

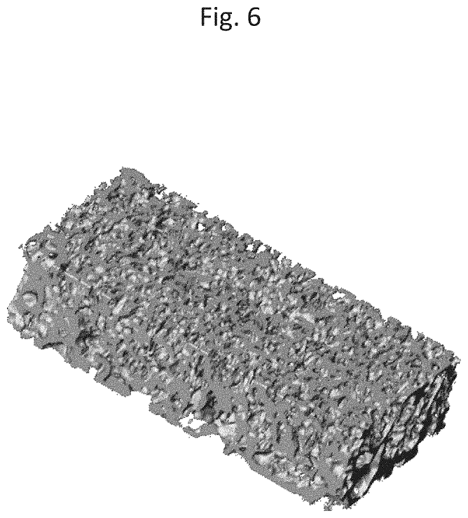

In SEM images obtained for Sample 1, regions were distinguished by their color densities. A three-dimensional structure obtained by piecing together the regions 11 each formed of silicon carbide is shown in FIG. 5. In addition, a three-dimensional structure obtained by piecing together the regions 12 each formed of chromium diboride is shown in FIG. 6.

From FIG. 5 and FIG. 6, it was able to be understood that silicon carbide and chromium boride in Sample 1 each had a three-dimensional network structure, and the structures tangled with each other complicatedly. A region confirmed for the three-dimensional network structures by FIB-SEM measured 60 μm by 45 μm by 160 μm, which was much larger than the median values of particle diameters of the silicon carbide powder and the chromium diboride powder serving as raw materials, and hence it was presumed that these materials were melted during the shaping and connected to each other.

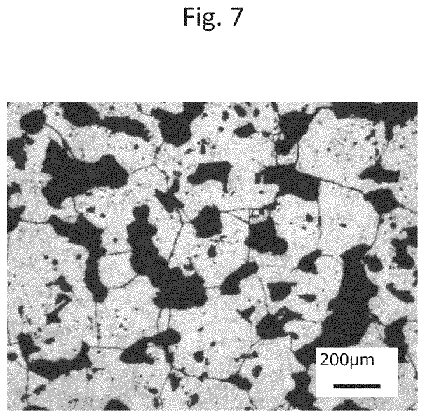

Next, the pores included in the shaped object 110 were calculated. It was considered that the pores were included therein evenly because the thermal conductivity of the shaped object did not largely vary except for an end portion, a joined portion to the plate, an outermost surface, and the like. In view of the foregoing, a porosity was defined as follows: an optical micrograph of a portion having even pores in a cross section of the shaped object except for the end portion, the joined portion to the plate, the outermost surface, and the like was acquired; and, in a field corresponding to a region measuring 2.44 mm by 1.63 mm, a ratio of a dense-colored portion corresponding to the pores to the field was regarded as the porosity. An optical micrograph of a region having even pores in a cross section of Sample 1 is shown in FIG. 7. At each of several positions (10 or more positions) presumed to have even pores, a threshold value was set in terms of density, and in image analysis, a portion having a density higher than the threshold value was judged as pores. The porosity was calculated as an area ratio thereof with respect to an entire area, and the porosities were averaged. As a result, the porosity was calculated to be about 30%.

[Step of Impregnating Manufactured Shaped Object with Metal Silicon]

Next, the shaped object 110 was impregnated with metal silicon. As illustrated in FIG. 2, alumina spherical objects 202 of 1 mmϕ were spread so that a thickness does not become a thickness equal to or more than two layers at the bottom of the crucible 201 made of graphite, and one shaped object 110 was placed thereon.

Further, the metal silicon powder 203 (specific gravity: 2.33, particle diameter: 45 μm or less) having a volume 1.5 times as large as a volume corresponding to the porosity previously calculated was placed on the shaped object 110.

After that, the shaped object 110 and the metal silicon powder 203 were loaded in a vacuum heat treatment furnace (not shown) together with the crucible 201, an inside of the furnace was purged with argon, and then the temperature was heated from room temperature to 1,000° C. at a temperature increase rate of 300° C./h and retained at 1,000° C. for 2 hours. After that, while the pressure was reduced to an absolute pressure of 1.5 kPa in 40 minutes, the temperature was heated to 1,200° C. at a temperature increase rate of 300° C./h, and was subsequently heated to 1,500° C. at a temperature increase rate of 120° C./h and retained at 1,500° C. for 2 hours.

After that, the temperature was reduced to 1,424° C., which was immediately above the melting point of metal silicon, at a temperature decrease rate of 120° C./h, and was gradually cooled to 1,400° C. at a temperature decrease rate of 6° C./h.

Subsequently, the temperature was cooled at a temperature decrease rate of 300° C./h, and when the temperature reached 70° C. or less, dry air was introduced to return the pressure to the atmospheric pressure, and the crucible 201 was taken out from the vacuum heat treatment furnace.

By the above-mentioned method, two Samples 1, two Samples 2, and two Samples 3, that is, 6 samples in total were each impregnated with metal silicon. A product obtained by impregnating Sample 1 with metal silicon was used as Sample 6 (Example 1), a product obtained by impregnating Sample 2 with metal silicon was used as Sample 7 (Example 2), and a product obtained by impregnating Sample 3 with metal silicon was used as Sample 8 (Example 3).

Further, the alumina spherical objects adhering to the surface of the shaped object 110 in the step of impregnating the shaped object with metal silicon were removed, and its shape and surface were arranged by polishing. Thus, an article having a size of about 4 mm by about 40 mm by about 9 mm and including metal silicon was obtained.

[Characteristics of Article]

Next, Sample 1, Sample 2, Sample 3, Sample 6, Sample 7, and Sample 8 were each subjected to a three point flexural test in conformity with “Testing method for flexural strength of fine ceramics at room temperature” (JIS R 1601) of Japanese Industrial Standards. In addition, for each of those Samples, a rupture surface was polished, and a porosity was calculated based on an optical micrograph of the surface having been polished.

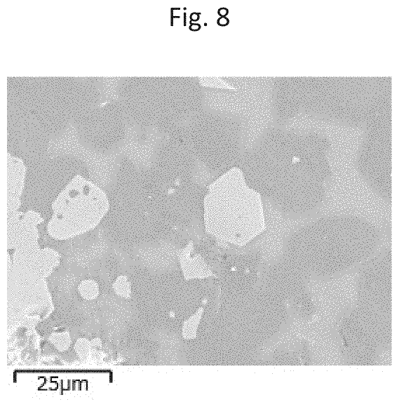

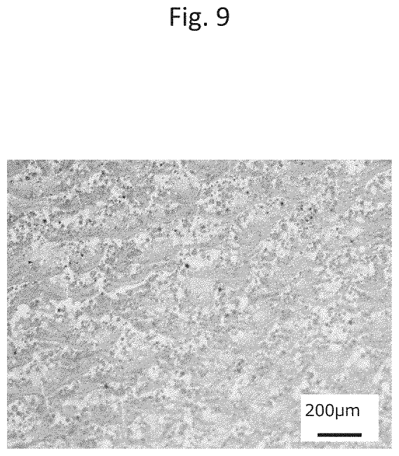

A SEM image of Sample 6 is shown in FIG. 8. As a result of composition analysis, it was found that, out of portions each occupying an area to some extent, a region 11 having the densest color was formed of silicon carbide, a region 12 having the lightest color was formed of chromium diboride, and a region 13 having a density between that of the region 11 and that of the region 12 was formed of metal silicon. In addition, a black portion 10 present in an island shape and in a slight amount between those materials corresponds to pores. In the same manner as in Sample 1, the porosity of Sample 6 was calculated based on an optical micrograph of a cross section thereof. The optical micrograph of the cross section of Sample 6 having even pores, which is used for the calculation of the porosity, is shown in FIG. 9. A threshold value was set in terms of density, and in image analysis, a portion having a density higher than the threshold value was judged as pores, and the porosity was calculated as an area ratio thereof with respect to an entire area. In addition, in the same manner as in Sample 1, whether a eutectic crystal or a hypoeutectic crystal was formed or not was judged based on the SEM image.

For other Samples, a porosity was calculated and whether a eutectic crystal or a hypoeutectic crystal was formed or not was judged in the same manner as in Samples 1 and 6. The results are shown in Table 2.

TABLE 2

| | | | | Presence or | | | | |
|---|---|---|---|---|---|---|---|---|
| | | | | absence of | | | | |
| | | | | eutectic crystal/ | | Flexural | | |
| | | Material | | hypoeutectic | Impregnation | strength | Porosity | Overall |
| | Numbering | powder | Shapability | crystal | with silicon | [MPa] | [%] | judgment |
| Comparative | Sample 1 | Powder 1 | good | Presence | Not | 5 | 28 | B |
| Example 1 | | | | | impregnated | | | |
| Comparative | Sample 2 | Powder 2 | good | Presence | Not | 7 | 32 | B |
| Example 2 | | | | | imphregnated | | | |
| Comparative | Sample 3 | Powder 3 | good | Presence | Not | 4 | 30 | B |
| Example 3 | | | | | impregnated | | | |
| Comparative | Sample 4 | Powder 4 | not good | Unknown | — | — | — | C |
| Example 4 | | | | | | | | |
| Comparative | Sample 5 | Powder 5 | not good | Unknown | — | — | — | C |
| Example 5 | | | | | | | | |
| Example 1 | Sample 6 | Powder 1 | good | Presence | Impregnated | 230 | ≤1 | A |
| Example 2 | Sample 7 | Powder 2 | good | Presence | Impregnated | 200 | ≤1 | A |
| Example 3 | Sample 8 | Powder 3 | good | Presence | Impregnated | 180 | ≤1 | A |

The overall judgment was performed as described below. A case in which an article having a shape measuring 4 mm by 40 mm by 9 mm was not able to be shaped was indicated by Symbol “C”. In addition, a case in which the article was able to be shaped, but had a porosity of about 30% and did not obtain sufficient flexural strength was indicated by Symbol “B”. Even such article is considered to be used for an application such as a filter. In addition, a case in which the obtained article had flexural strength (100 MPa or more) comparable to that of sintered ceramics was indicated by Symbol “A”, because such article is considered to be utilized in various applications.

Next, the reasons why Sample 1, Sample 2, and Sample 3 were able to be shaped, and the reasons why Sample 4 and Sample 5 were not able to be shaped are considered.

First, the reason why the shaped object was obtained in Sample 1, in which the shaping was performed by using mixed powder of silicon carbide and chromium diboride (melting point: 2,200° C.) having a melting point lower than the sublimation point (2,545° C.) of silicon carbide, is considered. When the mixed powder of silicon carbide and chromium diboride is irradiated with a laser beam and increased in temperature, first, chromium diboride reaches its melting point to be melded. Then, it is presumed that a state in which the surfaces of particles of silicon carbide are covered with molten chromium diboride is achieved. Although silicon carbide is sublimated alone, silicon carbide is considered to be melted at an interface between two substances, and the melting of silicon carbide proceeds from an interface between silicon carbide and molten chromium diboride. It is presumed that, even when the temperature is increased to reach the sublimation point of silicon carbide, volatilized silicon carbide dissolves in molten chromium diboride, and thus the volatilization of silicon carbide is suppressed. Therefore, even when the temperature becomes such high temperature as to exceed the sublimation point of silicon carbide by the irradiation with a laser beam, a state in which silicon carbide and chromium diboride are melted is maintained. After that, when an irradiation time with a laser beam is ended and the temperature of an irradiation region is turned to reduce, silicon carbide and chromium diboride each start to be deposited, and it is presumed that a state illustrated in FIG. 4 in which both the substances are mixed with each other without a gap is achieved. It is considered that the same applies to Sample 2 using mixed powder of silicon carbide and vanadium diboride, and Sample 3 using mixed powder of silicon carbide and chromium monoboride.

Next, the reason why a desired shaped object was not obtained in Sample 4, in which the shaping was performed by using mixed powder of silicon carbide and titanium diboride (melting point: 2,920° C.), which was a metal boride having a melting point higher than the sublimation point of silicon carbide, is considered. When the mixed powder of silicon carbide and titanium diboride is irradiated with a laser beam and increased in temperature, the temperature reaches the sublimation point of silicon carbide in advance of the melting point of titanium diboride. Therefore, silicon carbide starts to be sublimated first, and after that, titanium diboride starts to be melted. On the surfaces of particles of silicon carbide, contact between molten titanium diboride and the silicon carbide powder is inhibited by a sublimated gas, and their contact is extremely limited. In addition, silicon carbide continues to be sublimated for a time in which titanium diboride is melted, and hence a contact area between these substances is not increased. As described above, the melting of silicon carbide is extremely limited, and silicon carbide is rarely deposited even through cooling. Therefore, it is considered that a shaped object in a state in which eutectic crystals or hypoeutectic crystals closely tangle with each other is not obtained, unlike the cases of Samples 1 to 3, and a fragile shaped object in which a boundary between silicon carbide and titanium diboride has weak bonding is obtained.

From the above-mentioned hypothesis and experimental results, it is considered that, when the shaping is performed by using a powder material including the silicon carbide powder and the metal boride powder having a melting point lower than the sublimation point of silicon carbide, a state in which eutectic crystals or hypoeutectic crystals tangle with each other without a gap is achieved, and the shaping can be performed with a boundary having strong bonding.

Next, Samples 1, 2, and 3, and Samples 6, 7, and 8 obtained by impregnating Samples 1, 2, and 3 with metal silicon, respectively, are considered. When the pores included in the shaped object 110 immediately after the shaping are impregnated with metal silicon, the porosity, which is about 30%, is almost lost (1% or less). From the fact, it is presumed that almost all the pores included in the shaped object 110 immediately after the shaping three-dimensionally communicate to each other.

In addition, the flexural strength was increased to about 20 times to about 30 times, which was higher than the flexural strength (generally said to be about 200 MPa) of metal silicon. A three-dimensional structure formed of metal silicon in itself is considered to occupy a volume of about 30% with respect to the article, and hence an increase in flexural strength caused by the impregnation with metal silicon is estimated as follows: 200 MPa×30%=about 60 MPa. However, in actuality, the flexural strength in as-shaped condition was increased from 5 MPa to 230 MPa by 225 MPa. This is presumably because three-dimensional structures formed of silicon carbide, chromium diboride (or vanadium diboride or chromium monoboride), and metal silicon are brought into contact with each other and three-dimensionally tangle with each other, and with this, flexural strength that cannot be easily predictable is achieved. In addition, it can be presumed that the filling of the pores with metal silicon, which prevents the generation and development of cracks, also contributes to an increase in strength.

[Mixing Ratio Between Silicon Carbide Powder and Metal Boride Powder]

Next, a mixing ratio between silicon carbide and chromium diboride suitable for the shaped object was examined by using powder obtained by mixing silicon carbide powder and chromium diboride powder. The same silicon carbide powder and the same chromium diboride powder as in Powder 1 were used as the silicon carbide powder and the chromium diboride powder.

When the entirety of mixed powder of silicon carbide and chromium diboride was defined as 100%, mixed powders including the chromium diboride powder at a molar ratio of 7.0%, 10%, 30%, 50%, 65%, and 70% were used as Powders 6 to 11, respectively. Articles serving as Samples 9 to 14 were manufactured by using those powders in the same manner as in the shaping using Powders 1 to 5, and were used as Comparative Example 6 to 11, respectively.

In the case of Powder 6, which had a high ratio of silicon carbide, a previous powder layer, that is, the outermost layer was peeled off at the time of forming a next powder layer after the shaping of 30 layers. Although the shaping was able to be continued, the same phenomenon occurred every time a new powder layer was formed, and as a result, the shaping was not able to be continued. Meanwhile, in the case of Powder 11, which had a high ratio of chromium diboride, ball-like protrusions were formed on the surface during the shaping, and the outermost layer was peeled off because a roller touched the protrusions at the time of forming the powder layer, and as a result, the shaping was not able to be continued. The ball-like protrusions were analyzed later, and as a result, were found to include chromium diboride as a main component. A possible reason for this is that molten chromium diboride was increased in purity, and hence liquid droplets formed on the surface had high surface tension and aggregated with each other to be increased in diameter, and then solidified.

In addition, Samples 15 to 18 were manufactured by manufacturing samples in the same manner as in Samples 10 to 13, and subjecting the samples to an impregnation step with metal silicon. The impregnation step with metal silicon was able to be performed with no problem. Samples 15 to 18 were used as Examples 4 to 7, respectively. In addition, the samples, which were able to be shaped, were each subjected to a three point flexural test and calculated for a porosity in the same manner as in the above-mentioned examples.

The results are shown in Table 3. A value of (mol % of silicon carbide)/(mol % of chromium diboride) is shown in the column of a molar ratio.

TABLE 3

| | | | Silicon | Chromium | | | | Flexural | | |
|---|---|---|---|---|---|---|---|---|---|---|
| | | Material | carbide | diboride | Molar | | Impregnation | strength | Porosity | Overall |
| | Numbering | powder | [mol %] | [mol %] | ratio | Shapability | with silicon | [MPa] | [%] | judgment |
| Comparative | Sample 9 | Powder 6 | 93 | 7 | 13.3 | not good | — | — | — | C |
| Example 6 | | | | | | | | | | |
| Comparative | Sample 10 | Powder 7 | 90 | 10 | 9 | good | Not | 7 | 28 | B |
| Example 7 | | | | | | | impregnated | | | |
| Comparative | Sample 11 | Powder 8 | 70 | 30 | 2.3 | good | Not | 5 | 28 | B |
| Example 8 | | | | | | | impregnated | | | |
| Comparative | Sample 12 | Powder 9 | 50 | 50 | 1 | good | Not | 5 | 32 | B |
| Example 9 | | | | | | | impregnated | | | |
| Comparative | Sample 13 | Powder 10 | 35 | 65 | 0.54 | good | Not | 5 | 30 | B |
| Example 10 | | | | | | | impregnated | | | |
| Comparative | Sample 14 | Powder 11 | 30 | 70 | 0.43 | not good | — | — | — | C |
| Example 11 | | | | | | | | | | |
| Example 4 | Sample 15 | Powder 7 | 90 | 10 | 9 | good | Impregnated | 200 | ≤1 | A |
| Example 5 | Sample 16 | Powder 8 | 70 | 30 | 2.3 | good | Impregnated | 230 | ≤1 | A |
| Example 6 | Sample 17 | Powder 9 | 50 | 50 | 1 | good | Impregnated | 180 | ≤1 | A |
| Example 7 | Sample 18 | Powder 10 | 35 | 65 | 0.54 | good | Impregnated | 190 | ≤1 | A |

It was found that, when the total amount of the mixed powder was defined as 100%, powder having a molar ratio between silicon carbide and chromium diboride, silicon carbide:chromium diboride, falling within a range of from 90:10 to 35:65 was suitable for the shaping. That is, it was found that mixed powder having a molar ratio of silicon carbide to chromium diboride, silicon carbide/chromium diboride, falling within a range of 0.54 or more and 9.00 or less was suitable for the shaping. Further, it was able to be confirmed that the flexural strength of the article obtained by impregnating the shaped object with metal silicon was increased more than expected.

While a two-component system that is focused on silicon carbide and chromium diboride, and includes, for example, silicon carbide and chromium monoboride, or silicon carbide and vanadium diboride has been investigated in the above-mentioned Examples, the appropriate addition of various boron-containing materials, such as titanium boride, lanthanum boride, and boron carbide, in a range in which main characteristics are not changed does not depart from the present disclosure. It is sometimes effective to reduce a specific gravity, increase strength, and the like, and hence the various boron-containing materials may be appropriately used.

Further, while the powder having a median value of particle diameters of 5 μm was used as chromium diboride and the powder having a median value of particle diameters of 9 μm was used as chromium monoboride in the above-mentioned Examples, those powders were used merely for their availability for commercial distribution. The use of those powders does not limit the utilization of powder having a different particle diameter. However, the metal boride to be mixed preferably has a particle diameter smaller than that of silicon carbide, that is, a particle diameter of 10 μm or less so that the metal boride is easily melted.

In addition, while the shaping was performed by powder bed fusion using a laser in the above-mentioned Examples, the shaping method is not limited to this method, and other three-dimensional shaping methods each undergoing a similar thermal history may also be applied. For example, powder bed fusion using an electron beam, and further, direct energy deposition involving ejecting a gas and material powder simultaneously, and melting the powder by a laser may also be applied.

In addition, while the metal silicon powder was placed on the shaped object and melted in the step of impregnating the shaped object with metal silicon in the above-mentioned Examples, a metal silicon wafer, metal silicon pellets, or the like may be used instead of the metal silicon powder, and further, a method called an MI method involving immersing the shaped object in molten metal silicon, and pulling up the shaped object may also be used.

The shaping of silicon carbide, which has been difficult to perform by the related-art three-dimensional shaping methods, can be performed. For example, the shaped object formed of a eutectic crystal of silicon carbide and a metal boride can be utilized for a heat exchanger, an engine nozzle, a stage, and the like by virtue of high heat resistance, high thermal conductivity, and high physical strength.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A method of manufacturing an article comprising:
forming a shaped object by repeating:
forming a powder layer through use of a mixed powder of a powder containing silicon carbide and a powder containing a metal boride having a particle diameter smaller than that of silicon carbide and a melting point lower than a sublimation point of silicon carbide; and
simultaneously scanning and irradiating the formed powder layer with an energy beam based on shape data of an object to be shaped to melt and solidify the mixed powder; and
further impregnating the shaped object with metal silicon.

2. The method according to claim 1, wherein the metal boride comprises at least one selected from the group consisting of chromium diboride, vanadium diboride, and chromium monoboride.

3. The method according to claim 2, wherein the metal boride is chromium diboride, and
wherein the article has a molar ratio between silicon carbide and chromium diboride, silicon carbide:chromium diboride, of from 90:10 to 35:65.
